(19) United States
(12) Patent Application Publication
(10) Pub. No.: US 2014/0237096 A1
(43) Pub. Date: Aug. 21, 2014

(54) SYSTEM FOR PROVIDING DISTRIBUTED DEVICE RESOURCE-OBJECT-CONNECTION SERVICE BASED ON SERVICE DELIVERY PLATFORM

(71) Applicant: Electronics and Telecommunications Research Institute, Daejeon (KR)

(72) Inventors: Chang-Woo YOON, Daejeon (KR); Nam-Kyung LEE, Daejeon (KR); Tai-Won UM, Seoul (KR)

(73) Assignee: Electronics and Telecommunications Research Institute, Daejeon (KR)

(21) Appl. No.: 14/037,161

(22) Filed: Sep. 25, 2013

(30) Foreign Application Priority Data
Feb. 18, 2013 (KR) 10-2013-0017080

(51) Int. Cl. H04L 12/24

(52) U.S. Cl. CPC H04L 41/0803
USPC 709/223

(57) ABSTRACT

A system for providing a distributed device resource-object-connection service based on a service delivery platform (SDP), the system including: an SDP configured to define distributed service functions as enablers, generate a convergence service by combining the enablers, and provide the generated convergence service; and a proxy configured to connect a distributed device and an SDP to allow the SDP to use the distributed device as a resource, and define and use the distributed device as an enabler.

### CROSS-REFERENCE TO RELATED APPLICATION(S)

This application claims priority from and the benefit under 35 U.S.C. §119(a) of Korean Patent Application No. 10-2013-0017080, filed on Feb. 18, 2013, which is hereby incorporated by reference for all purposes as if fully set forth herein.

### BACKGROUND

1. Field

The following description relates to service delivery platform (SDP) that is capable of dividing services in units of independent enablers, generating a convergence service by combining the divided services, and providing the generated service.

2. Description of the Related Art

With the increase in the number of terminals used by individual users and devices connected with sensors, cameras, and the like, Web of Object (WoO)-based services have been introduced. WoO delivers a variety of services that requires the use of devices located physically near the users. Important factors for implementation of such WoO-based service are connection of terminals, such as wireless devices, to the network, and the provision of functions required for the service.

Generally, a service delivery platform (SDP) has been widely used to provide a convergence service, which combines the existing distributed service functions in a standard. SDP generally refers to a system that deals with a web service standard that provides a convergence service, that is, a new web service, by mashing up distributed service functions. Korean Patent Registration No. 10-1001554 discloses a registration of an enabler in an SDP. In this method, service is provided using an enabler provided by the SDP, and a user is allowed to register an enabler that is not provided by the SDP, and thereby enabling a user of another service to use the service. In other words, when providing a new service using the SDP, the user is allowed to register an enabler associated with the new service in the SDP, so that the implementation cost for a separate additional system can be reduced, and other users can reuse the enabler. However, in the existing methods, service functions are defined as enablers that can exist independently of each other, and the combination of the enablers is provided as a convergence service.

### SUMMARY

The following description relates to a system for providing distributed device resource-object-connection service based on a service delivery platform (SDP), a system capable of defining distributed service functions as well as distributed devices as enablers, and thereby allowing the distributed devices to be used in the same sense as service-function enablers.

In one general aspect, there is provided a system for providing a distributed device resource-object-connection service based on a service delivery platform (SDP), the system including: a SDP configured to define distributed service functions as enablers, generate a convergence service by combining the enablers and provide the generated convergence service; and a proxy configured to connect a distributed device and an SDP to allow the SDP to use the distributed device as a resource, and define and use the distributed device as an enabler.

The proxy may convert a communication protocol for data transfer between the distributed device and the SDP.

The proxy may filter data to be delivered to the SDP according to predetermined rules. The proxy may be connected to an application program interface (API) of the distributed device in response to a function request from the SDP to the distributed device.

The system may further include a gateway configured to convert a communication protocol for data transfer between the distributed device and the proxy.

The gateway may be dedicated for a distributed device that does not include a web server.

The gateway may be configured to extract meaningful data from data received from the distributed device by performing semantic-based processing, and to transfer the extracted data to the proxy.

Other features and aspects will be apparent from the following detailed description, the drawings, and the claims.

### BRIEF DESCRIPTION OF THE DRAWINGS

FIG. 1 is a diagram illustrating a system for providing distributed device resource-object-connection service based on a service delivery platform (SDP).

FIG. 2 is a diagram illustrating a gateway according to an exemplary embodiment of the present invention.

FIG. 3 is a diagram illustrating a proxy according to an exemplary embodiment of the present invention.

FIG. 4 illustrates a diagram illustrating a WoO service that can be implemented using a system according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

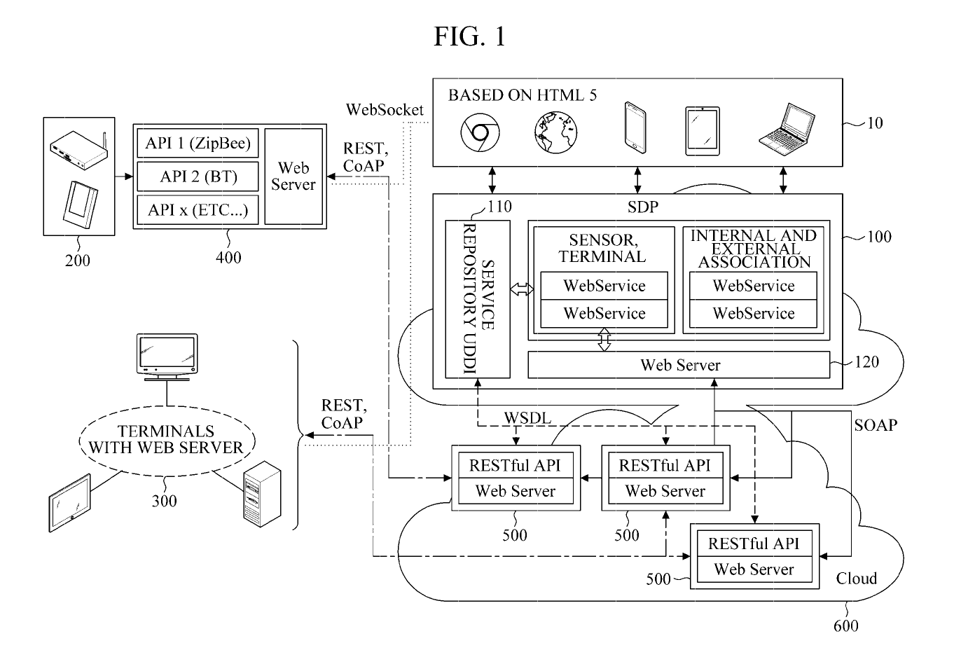

FIG. 1 illustrates a diagram of a system for providing distributed device resource-object-connection service based on a service delivery platform (SDP) according to an exemplary embodiment of the present invention.

A service delivery platform (SDP) 100 is a service platform that defines service functions as enablers, generates a new web service by the combination of the enablers, and delivers the created web service.

Whereas a general SPD defines only service functions as enablers, the SDP 100, according to an exemplary embodiment of the present invention, uses distributed devices as a resource, and provides them as device enablers, so that the distributed devices can be used to generate and deliver a Web of Object (WoO) convergence service in the same way a general service function enabler is used. A number of factors may be considered in using devices as service elements to generate a new service needed by a user. First, a service is associated with a number of devices that are distributed. Thus, the distributed devices should be integrated within the same network so as to provide a single convergence service. Second, a service cannot be formed by devices alone. A device and a necessary service function should be combined together in order to provide a particular service that the user needs. Thus, the present invention provides a method of associating distributed devices, such as a sensor 200, a mobile terminal 300, and the like, with the SDP 100 to enable the distributed devices to be used for the service.

The distributed devices may include non-web-server-equipped devices and web server equipped devices. The non-web-server-equipped devices may include sensors 200, such as temperature sensors, humidity sensors, and the like. The web-server equipped devices may include terminals 300, including TVs and smartphones, which have ample hardware resources, such as memory. The sensors 200 use light-weight protocols, such as ZigBee® and Bluetooth®, due to limited memory resources available for communication. However, the SDP 100 uses heavyweight web service protocols since it is operated by a server. The web service protocols used by SDP 100 include Web Service Description Language (WSDL) to describe services, Universal Description Discovery and Integration (UDDI) 110 to store described services, and Simple Object Access Protocol (SOAP) for communications. In addition, the system includes a web server 120 to operate web-based services.

The sensor 200 requires protocol conversion to communicate with the SDP 100 that uses a different protocol. To this end, the sensor 200 needs a gateway 400. The WoO gateway 400 converts lightweight protocols, such as ZigBee®, Bluetooth®, and the like, into web service-based protocols. Due to an embedded system generally used by the gateway 400, the gateway 400 uses lightweight web service-based protocols, such as Representational State Transfer (REST) and Constrained Application Protocol (CoAP). Because the terminals 300 have a web server installed therein, they use such web service-based protocols as mentioned above, and thus do not need the gateway 400.

A proxy 500 connects the sensor 200 and the terminals 300 to the SPD 100. The proxy 500 converts a communication protocol for data transfer between the gateway 400 and the SDP 100, or between the terminal 300 and the SDP 100. In addition, since generally a large amount of data generated by the sensor 200 and terminals 300 is delivered to the proxy 500, effective processing of services may be ensured if meaningful data is extracted from the massive amount of data, and delivered to the SDP 100. In this regard, the proxy 500 performs semantic-based processing on the data transferred from the sensor 200 and terminals 300, performs protocol conversion on the processed data to SOAP, and transmits resulting data to the SDP 100. The proxy 500 may exist on cloud 600. As the proxy 500 is located on the cloud 600, it is possible to operate the proxy 500 on a service-by-service basis when necessary.

The system described above enables the capability of the SDP to be extended, so that functions of devices can be handled in the same way the service functions are handled, wherein the general capability of SDP only relates to the combination of the existing service functions, and thus it is possible to effectively generate and transmit a WoO service by combining various functions of devices.

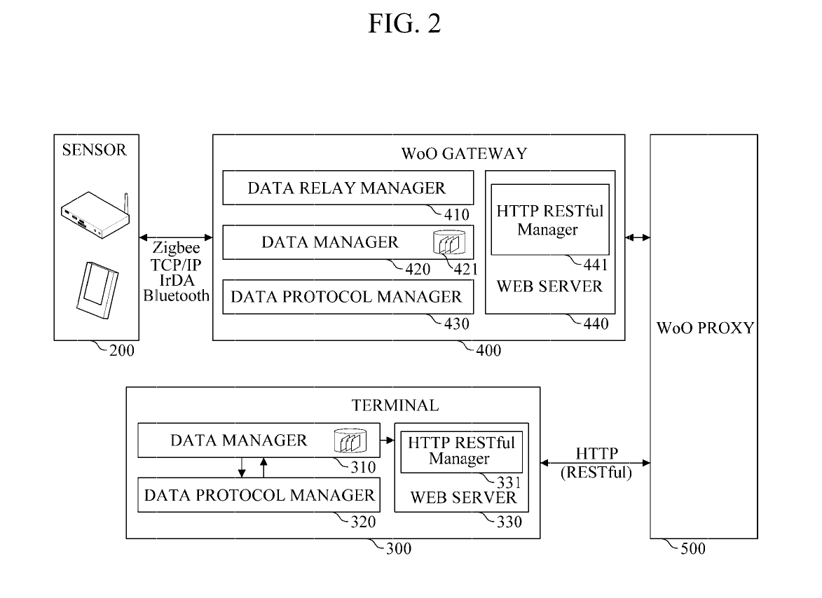

FIG. 2 illustrates a diagram of a WoO gateway according to an exemplary embodiment of the present invention.

As shown in FIG. 2, a WoO gateway 400 includes a data relay manager 410, a data manager 420, a data protocol manager 430, and a web server 440. The data relay manager 410 receives data from sensors 200 via a lightweight protocol, such as ZigBee®, Bluetooth®, and the like, and delivers the data to the data manager 420. The data manager 420 filters the data received from the data relay manager 410 according to predetermined rules 421. As aforementioned, it is required to extract meaningful data from a large amount of data generated by the sensors 200, and thus, the data manager 420 performs semantic-based processing to filter the data according to the predetermined rules 421, thereby extracting the meaningful data. The data protocol manager 420 delivers the filtered data to the web server 440 in application program interface (API) form, in order to convert the lightweight protocol, such as ZigBee®, Bluetooth®, and the like, to a web service-based protocol. A Hyper Text Transfer Protocol (HTTP) RESTful manager 441 of the web server 440 converts a protocol of the delivered data to the web service-based protocol, and then delivers the protocol-converted data to a WoO proxy 500. In addition, the HTTP RESTful manager 441 of the web server 440 performs protocol conversion on the data received from the SDP 100 through the WoO proxy 500, and delivers the converted data to the data protocol manager 430 in the form of an API instruction.

The delivered data is finally transferred to the sensor 200 through the data manager 420 and the data relay manger 410.

A terminal 300 includes a data manager 310 and a data protocol 320 therein because it does not require gateway 400, and a web server 330 includes an HTTP RESTful manager 331. The data manager 310, the data protocol manager 320, and the HTTP RESTful manager 331 serve the same functions as the data manager 420, the data protocol manager 430, and the HTTP RESTful manager 441, respectively.

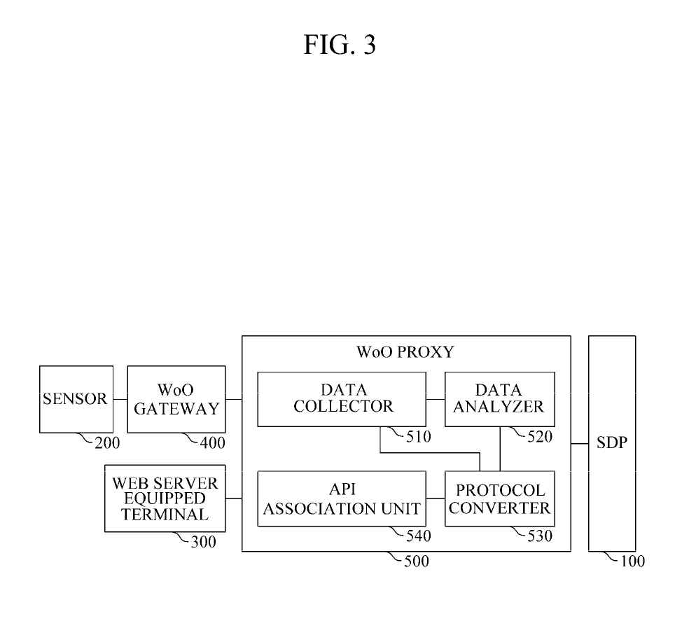

FIG. 3 illustrates a diagram of a proxy according to an exemplary embodiment of the present invention.

As shown in FIG. 3, a proxy 500 includes a data collector 510 and a protocol converter 530, and may further include a data analyzer 520. The data collector 510 collects data that is transferred from a sensor 200 through a gateway 400 and data that is directly transferred from a terminal 300. The collection of data is delivered to the data analyzer 520. The data analyzer 520 may perform knowledge processing, such as filtering of intended data to be transmitted to the SDP 100 according to predetermined rules, metadata extraction, sematic analysis, and the like. In one example, the data analyzer 520 performs knowledge processing on data for each service, based on service context, thereby transforming meaningless data into meaningful data. By doing so, an upper SDP can reduce its burden in terms of execution of service convergence. In addition, the data analyzer 520 can serve a function as a knowledge-based device connecting API. The protocol convertor 530 converts protocols for data transfers between the WoO gateway 400 and a SDP 100, or between the terminal 300 and the SDP 100. For example, the protocol converter 530 converts from REST to SOAP for data transfer to the SDP 100 and from SOAP to REST for data transfer to the WoO gateway 400 or the terminal 300. In addition, the proxy 500 may further include an API association unit 540. The API association unit 540 performs data input/output operations by connecting to an API of a relevant distributed device upon request from a service function of the SDP 100.

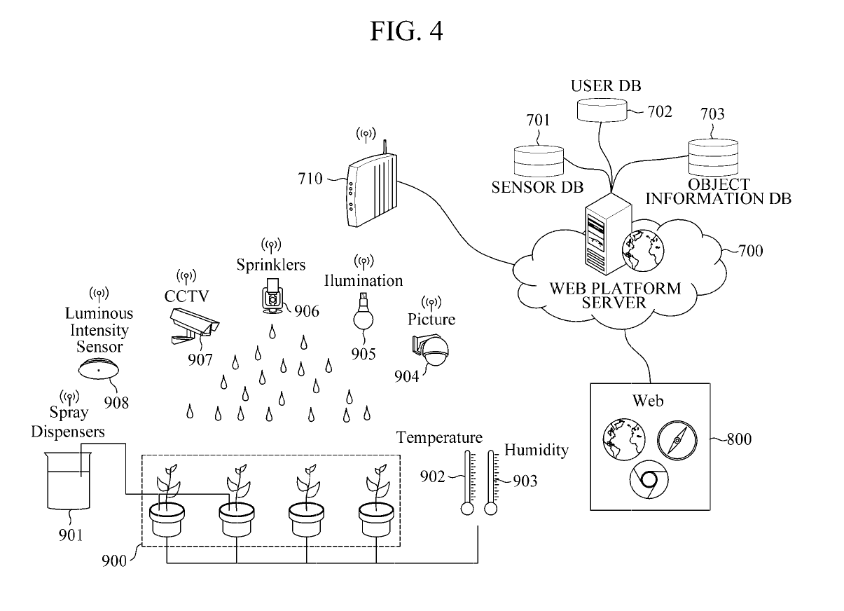

FIG. 4 illustrates a diagram of a WoO service that can be implemented in a plant watering system according to an exemplary embodiment of the present invention.

The WoO service shown in FIG. 4 is an automatic plant watering system, in which various sensors cooperate together to automatically water plants when necessary. A device enabler extended SDP 700, with various databases, including a sensor database (DB) 701, a user DB 702, and an object information DB 703, stores different data required for providing a service. The sensors are connected to the SDP 700 via a wireless access point (AP) 710. A temperature sensor 902 and a humidity sensor 903 monitor the state of plants, and the plants are watered at a preset time, or when a sensor data processing result determines that watering is required. A camera 904 or a closed circuit TV (CCTV) 907 monitors the watering system, and the light 905 is controlled to adjust the illuminance. The brightness of the light 905 is determined according to the illuminance, which is sensed by an illuminance sensor 908.

As described above, the system according to the exemplary embodiments of the present invention has distributed sensors, delivers data to the SDP 100, and executes a control instruction transferred from the SDP 100. Functions of the sensors exist in the SDP 100 as device function enablers, which are combined with service functions, and thereby a new web service can be generated.

The current embodiments can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for providing a distributed device resource-object-connection service based on a service delivery platform (SDP), the system comprising:
a SDP configured to define distributed service functions as enablers, generate a convergence service by combining the enablers and provide the generated convergence service; and
a proxy configured to connect a distributed device and an SDP to allow the SDP to use the distributed device as a resource, and define and use the distributed device as an enabler.

2. The system of claim 1, wherein the proxy converts a communication protocol for data transfer between the distributed device and the SDP.

3. The system of claim 2, wherein the communication protocol of the proxy for data transfer to the SDP is Simple Object Access Protocol (SOAP).

4. The system of claim 2, wherein the proxy filters data to be delivered to the SDP according to predetermined rules.

5. The system of claim 2, wherein the proxy is connected to an application program interface (API) of the distributed device in response to a function request from the SDP to the distributed device.

6. The system of claim 2, wherein the proxy is run on cloud.

7. The system of claim 1, further comprising:
a gateway configured to convert a communication protocol for data transfer between the distributed device and the proxy.

8. The system of claim 7, wherein the gateway is dedicated for a distributed device that does not include a web server.

9. The system of claim 8, wherein the gateway is configured to extract meaningful data from data received from the distributed device by performing semantic-based processing, and to transfer the extracted data to the proxy.
